(19) United States
(12) Patent Application Publication
(10) Pub. No.: US 2008/0124054 A1
(43) Pub. Date: May 29, 2008

(54) Portable media player

(76) Inventor: Terence Bonar, Dunlaoighre (IE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/524,032

(22) Filed: Sep. 19, 2006

(51) Int. Cl. H04N 7/26

(52) U.S. Cl. 386/124

(57) ABSTRACT

The invention provides a portable media player of the type used in in-flight entertainment systems on flights and the like. By providing an activation code that is available to a user on purchase of a card, the user may enter the code and then select and view appropriate media content as determined by the specific code.

### FIELD

The present invention relates to portable media players and in particular to portable media players configured to provide a plurality of user selectable audio visual items depending on the selection of the user.

### BACKGROUND

Within the context of entertainment systems used on board planes and other transport vehicles such as buses, trains or ships, it is known to provide entertainment systems for personal use by a user. While it will be appreciated that the entertainment systems may be used on any type of transport vehicle, for the sake of explanation the present invention will be described in the context of in-flight entertainment systems provided on board aircraft.

Traditionally such entertainment systems were provided as integrated systems within the fabric of the vehicle—be that in the seat rests of the seats in front of the user or mounted throughout the cabin of the vehicle. In these deployments the user had little personal selection available to them.

In the earliest developments of such systems, individual screens were provided to each user which were physically connected to the seat where the user was located and were powered through a power supply provided to the seat. Using a menu system, the user could select a personal choice of audio or visual entertainment and then view that at his/her leisure. Such devices were linked to a centrally located storage system that held the available choices. To install such a system the operator of the airplane or other transport vehicle had to invest heavily in an upgrading of their seats and on board communications systems.

In recent times developments in such in-flight entertainment systems have led to hand-held or portable devices. The portable device is a stand-alone unit that has stored thereon the available content for the user to view. It is necessary therefore for such devices to have an internal memory, and devices incorporating hard drives or the like are known. Other examples include portable DVD players. Such devices are stored centrally on-board and distributed to the passengers as required by the flight attendant. This is advantageous in that there is no requirement for modification of the seats to facilitate the incorporation of such systems.

A disadvantage of such systems incorporating a plurality of such devices arises from the fact that the content provided on that device is stored on that device. Viewing choices and preferences will depend on the user of the device and it is therefore necessary to have a wide variety of available media for viewing by the user. There are also issues with regard to content within the context of censorship rules in that there is a requirement to ensure that the available content that is viewable by a user is appropriate to that viewer's age.

An additional problem with regard to the storage of all media on the data store of the device arises from the size of such data, and also where there is a requirement to provide support for multiple languages which can require multiple copies of the essentially the same media item being stored. Such issues can affect capacity capabilities. With capacity for such devices being an issue, it is difficult for a content provider to provide a large volume of content for subsequent viewing.

Further issues arise with regard to the charging rates for that content. The suppliers of the media—be that audio, visual or gaming content—are able and do charge for that content. The requirement to pay the requisite royalty to the copyright or other rights owner can persuade the provider of the entertainment system to limit the available content. While they are only obliged to pay for the content that is actually viewed by the viewer, it is not currently possible to monitor this, and as a result the current practice is to pay for all content stored on the device, and usually on a per flight segment basis.

Further issues arise in the deployment of such systems in that the many airlines will charge a passenger for use of the portable device. With the advent of low cost airlines it is becoming the norm that the ticket price will only include the cost of the flight and that any on-board food or entertainment is charged as a separate item. In this context it is known to require a payment for such devices. Known systems address this by providing a credit card swipe mechanism on the portable device which enables a user to effect payment for their use of the device using their credit card. The user effects a choice of content to view or listen and then pays the appropriate price for that content. While this addresses the issue of payment, the manner in which it is achieved is not optimal in that in order to process that payment it is necessary for each device to be then returned to a central interface to download the payment details. This can be a cumbersome activity.

For these reasons and others it will be understood that there are a number or problems associated with known portable entertainment systems.

### SUMMARY

The present invention addresses these and other problems by providing a portable entertainment device which includes a data store having stored thereon a plurality of individual media content items, selected ones of the media content items being viewable by a user on the device on activation of the device, and wherein the device is activated by entry of an activation code by the user, the activation code determining the choice of media content items for subsequent user viewing.

Typically the device includes an externally accessible card reader, the card reader being configured to interface with a supplied card having provided thereon the activation code, the interface of the card with the reader providing for a reading of the activation code and subsequent activation of the system.

These and other features will be better understood with reference to the following drawings.

### BRIEF DESCRIPTION OF THE FIGURES

The present invention will now be described with reference to the accompanying drawings in which:

FIG. 1 is a schematic showing a portable entertainment device;

FIG. 2 is an architectural schematic showing in functional form components of the device of the invention;

FIG. 3 shows an example of a magnetic card that can be used to provide an activation code to the device of the invention; and

FIG. 4 shows how devices according to the teaching of the invention may be updated centrally using a content manager.

### DETAILED DESCRIPTION OF THE FIGURES

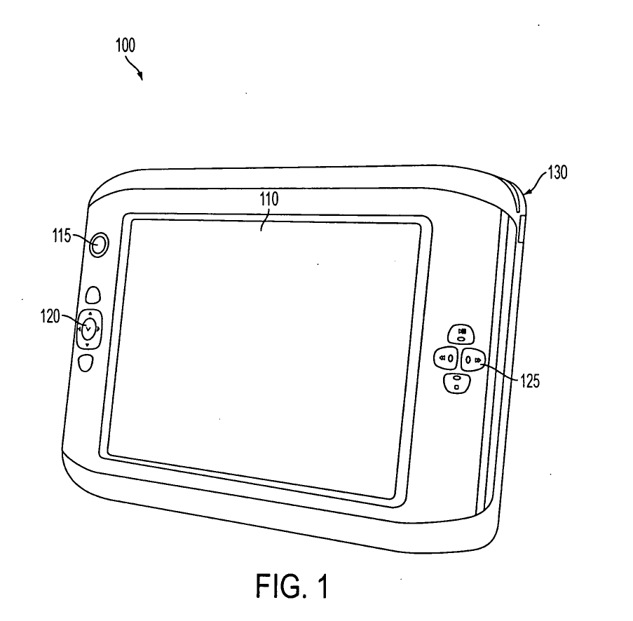

As shown in FIG. 1, a device 100 in accordance with the teachings of the invention is a portable handheld system including a screen 110 on which is displayable one or more media content items which are locally stored on the device. A user may power the system on or off using a power switch 115. Access to a menu and investigation of available content can be determined using a first set of controls 120 which are desirably positioned on one side of the screen 110. A second set of controls 125 is provided on the other side of the screen and may be used by a user to play one or more games, which may also be stored on the device. The type, configuration and usage of such controls will be well known to those skilled in the art of providing portable entertainment systems.

Provided on an external surface of the device is a card reader 130. Such a reader and/or writer combination is exemplary of the type of arrangement that may be used by a user to present an activation code to the device. In this arrangement, the card reader is a magnetic stripe type reader that is configured to read a magnetic stripe on a suitable card. The embedding of suitable codes into magnetic strips of cards will be well known to the person skilled in the art. In use, a user will obtain a suitable card from the flight attendant and then swipe the card along the card reader. The swiping action will enable the device to read the activation code. In accordance with the teaching of the invention the specifics of the activation code will determine the available content which is accessible by the user for viewing on the screen.

While the specifics of the card reader shown in FIG. 1 is a magnetic stripe card reader useful for reading magnetic stripe cards it will be understood that such an arrangement is exemplary of the type of arrangement that may be used by a user to input an activation code. Suitable other arrangements may include a smart card with a corresponding smart card reader or a writable screen where the user can manually enter a code given to them by the flight attendant.

It will be understood that by controlling the activation of the device by provision of an activation code by the flight attendant as opposed to enabling a credit card activation of the device, as is known from the prior art, that the present invention provides numerous advantages. These include the ability to control user access to the available content. While the device may have a plurality of media content items stored on the device, not all of these may be suitable for general viewing. It is possible to pre-associate certain code types with certain sub-sets of the available content so as to limit a user to specific media content items. In this way a child viewer can have their viewing limited to appropriate age content material, a sports fan can be provided access to specific sports programming and a person who wishes to view new releases can be provided with access to such new releases. Of course, each of these sub-sets of the available stored content may be associated with a different tariff profile.

Another advantage of centrally distributing the activation codes is that if payment is to be extracted for such viewing, that this can be centrally managed. The logistics of processing multiple devices—which is required if each device is activated using a personal credit or debit card—can be quite strenuous, especially if a large number of these are distributed during a flight. By centrally distributing the code, then the attendant may charge for these at the time of distribution. This may be done through a cash based payment or indeed by processing credit/debit cards. Further methods that could be used for prepaying for such devices include online reservation or distribution from vending machine prior to flight. In all these scenarios, the device itself does not provide for a processing of the financial transaction. Where a credit/debit card is centrally processed, there is not the subsequent problem of ensuring collection of each of the devices to transfer the payment details post usage of the device.

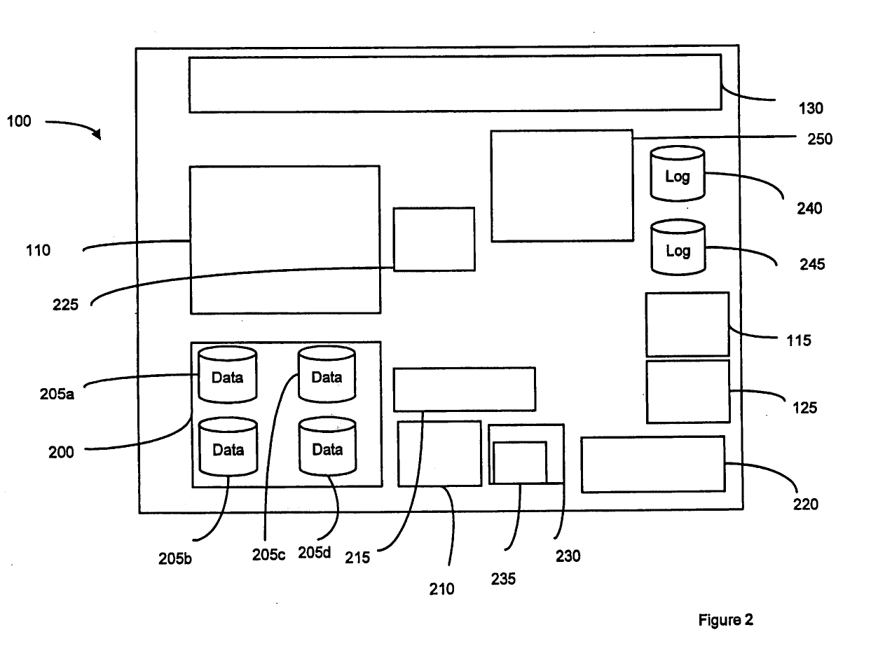

FIG. 2 shows in schematic form typical components of a device in accordance with the teaching of the invention. Similar numbering will be used for components previously identified in FIG. 1. As shown in this schematic, the device will include a data store 200 on which are storable a plurality of individual media content items 205a, 205b, 205c, 205d. These may be different movies, programs, music items or indeed games of one type or another. Each of the different media content items may be tagged to identify it as being of a specific type. Examples of tags may include genre, age viewing limitation, premium content, etc. While four individual sub-stores 205a-d are identified it will be understood that in accordance with memory management best practices that all or one of the contents of an individual sub-store could be provided on a single datastore—the differentiation shown here is purely for ease of explanation. The storage of individual media items could be differentiated into type—as above where the example of movies, TV programs was given, or indeed the individual visual component could be stored separately from its associated audio. This is particularly advantageous in scenarios where multiple audio tracks are required—in the case where translations of each program are provided and the user selects the appropriate language for viewing. Rather than store complete audiovisual files in each of the plurality of languages the data store arrangement of the present invention allows for a separation of the audio from the visual for storage purposes and then the recombination as appropriate on selection by the user. This separation could also be used for graphic formats where different fonts could be stored separately and presented as appropriate to the user on selection by the user of an appropriate language interface.

Within the context of the stored media content it will be appreciated that the format of the stored content may differ depending on the specific type of content. Examples of the type of supported media content include:

### Multimedia content (Movie/TV Programs/music videos)

### MPEG video+MP3 Audio's+text subtitles

### Multiple audio streams and subtitle streams are allowed with in the multimedia file to support different languages

### Audio content (Music/Audio book)

### MP3 format•

Games—games will be run in an interpreted environment—this is to ensure better security in the system as such programs cannot easily access system resources directly. Types of games may include those:

### Mainly 2D in nature

### Scrolling games

### Puzzles

### Java MIDP2 profile—commonly used in mobile telephones is the main environment that is targeted for games

As mentioned above the tagging of individual media content items may be used to define items of similar types. This may then be used to define content packages which may be considered as a directory of some pre-defined sub-directories (for example video, audio, games, meta data (image, short name and long description)) each having content of a specific type.

The content of the data store may therefore be considered a content package for that portable device. The device will support viewing of the specific media items available in the content package after verifying that the user has a valid activation code. The browsing of the contents available can be allowed without the need to use the activation code. In this way secondary files or preview files could be associated with each of the media content items, the secondary files being a brief resume of the actual full content. However once the user wants to view any content completely he has to provide the activation code. The device will verify the validity of the activation code and then allow the user to view the content, if so verified. It will be appreciated that while the activation code may define the specifics of the media content that the user may view, it may also be used to define the time period for which usage is valid. In this way the provider of the device—i.e. in this example the airline—can control the access for time periods specific to the flight. The time control element can therefore be used to dissuade users of the device from using their activation code for subsequent flights on other portable devices or indeed from taking the portable device with them when they leave the aircraft. In order to monitor this usage a log function 240 may be provided which monitors actual time usage of the device by a specific user code and deactivates the device once a predetermined period has expired.

As shown in the schematic of FIG. 2, in addition to the main memory 200 and display 110, the device includes a number of additional modules. It will be evident that power is required for operation of the device; this can be provided either by using an external power source such as using a power over Ethernet interface 210 to couple the device to an available power supply—for example one already provided in the seat of the user, or by powering directly from on-device batteries 215. These batteries are typically rechargeable and capable of providing about 10 hours of video playback. Such a configuration would satisfy most of the longest flights on which such a device would be used, but of course the specification of the battery could be modified depending on the deployment. Desirably the battery provided in each device is easily removable from the device. In this way a plurality of batteries may be provided so as to enable an easy replacement of a discharged battery when required.

As a purpose of the portable device is to provide a user with media content on the display 110, it is useful to provide an intuitive user interface. In a preferred embodiment the user interface 220 includes a file browser which is configured to pick up meta data from the content package, the meta data providing information about the specific individual media content items. In this way it is possible to provide a pleasing content browser to the user, without requiring an uploading of all information stored in the data store, thereby reducing the processing time and power requirements for completion of same.

It will be understood that as the devices of the present invention are intended for use with an international audience that specific users may have preferences about their interface language. The device of the present invention is capable of providing multiple language interfaces. By interrogating the meta data of the content package the system is capable of ascertaining whether a specific media content item is available in different languages and providing this indication to the user. The display is effected using a display engine 225 which drives the display 110 with appropriate parameters to effect a correct display. Using user interface controls 120, the user can then select their desired language for subsequent viewing purposes. The volume may be determined using a volume controller 230, but as most of these devices are used in a controlled volume area, typical usage will require headphones. As such it is necessary to provide an audio interface 235 to facilitate a physical interconnection of headphones with the device. Of course, it will be appreciated that other headset configurations may be achieved using wireless connection protocols such as Bluetooth etc., insofar as the use of these protocols is allowed in the deployment environment.

The device of the present invention may be provided in implementations that enable a logging of the viewed material. To facilitate this logging data registers 240, 245 may be provided to address two purposes. A first purpose, as discussed above, is to maintain a log 240 of the actual usage by a specific user with a specific activation code to ensure that that user is using the device within the permitted time period for that activation code. As each code will typically have a permitted time usage (either duration or period) it is important to regularly compare the actual usage with the permitted usage to confirm that the former is within the parameters allowed. A second log 245, which is desirably stored in a separate file, monitors the actual media content items viewed so as to provide an analysis of the viewing patterns. The purpose of this analysis is twofold—firstly it allows subsequent determination of the most popular viewed material to ensure that the content is updated appropriately and secondly it may be used to calculate royalty rates. As the actual royalty due to the owners of the property rights is determined on the basis of viewing as opposed to availability, by monitoring the actual viewing patterns a provider of content for devices of the present invention can be compensated for the actual media viewed. This is beneficial in that the installer of the content is not inclined to limit the available content on the device—they do not pay for all stored content, only that viewed. The user of the device is therefore offered more content than previously available using other known devices, allowing a more personalised selection. To ensure privacy of the user it is desirable that this second log does not associate the actual user with the program content viewed—instead simply an overview of the viewed content. It will be understood that as this second log has data representative of the total viewing patterns for that specific device that this log will not be refreshed as often as the first log—which is specific to the actual instant usage.

Overall control of the system is effected using an on device processor 250. Such operation of a plurality of devices using a processor will be apparent to the person skilled in the art.

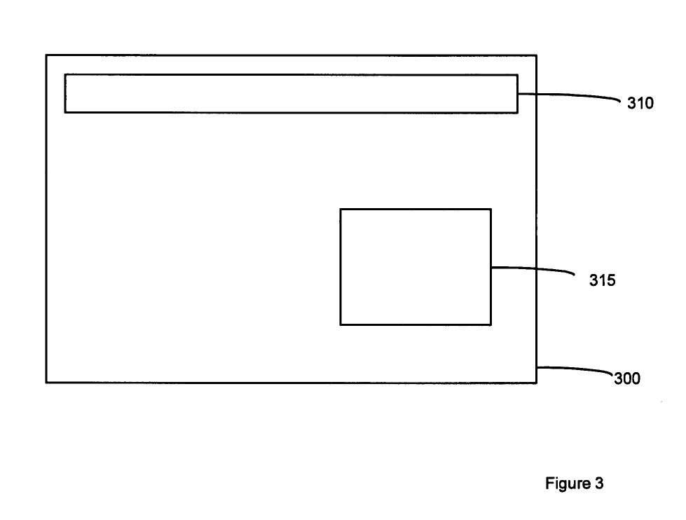

FIG. 3 shows an example of a typical access card 300 having an activation code embedded in the magnetic stripe 310 provided thereon. Specific portions 315 of the card may be reserved for branding or other advertising purposes. The information stored on the stripe and transferable to the device on interface of the card with the reader may typically include at a minimum validity period, total view/use hours available and a unique Card ID. The Card ID or a part of it could embed the provider of the service, for example the airline, identity implicitly. These contents in turn could be encrypted to make the cracking of its contents more difficult.

An example of the type of encryption that could be utilized is that based on the Data Encryption Algorithm (DEA), usually called DES or Data Encryption Standard. The idea behind DES is that a clear value is passed to the DES algorithm, which can be implemented either as software routines or in dedicated hardware. DES then encrypts the clear value using a key (a secret 64-bit value) and outputs an encrypted value. This can be subsequently decrypted using an equivalent key.

Furthermore, a checksum could be maintained as part of this card which uses an additional secret signature/data as part of its calculation. The checksum, if used, will be that of the unencrypted content and will be maintained unencrypted or will also be encrypted. The portable device will check the checksum in the access card to verify (to some extent) that the card has not been tampered with and that it comes from the appropriate source. Once the above checks succeed and the validity period is not yet over, the device will decrypt the keys as needed and use it to access the appropriate media contents in the package. The amount of memory in the access card technology used will decide the length of content package hash stored if any, and the length of checksum stored if any. Unless the card is provided using smart card technology, the interface with the device will not result in update of the access card, so the card in itself doesn't prevent misuse of it by being swiped in different devices within the validity period. However as each device will keep a log of what cards were used with it, a given card can't be reused in the same device and also, or alternatively, subsequent analysis of the logs can be used to identify the misuse of cards.

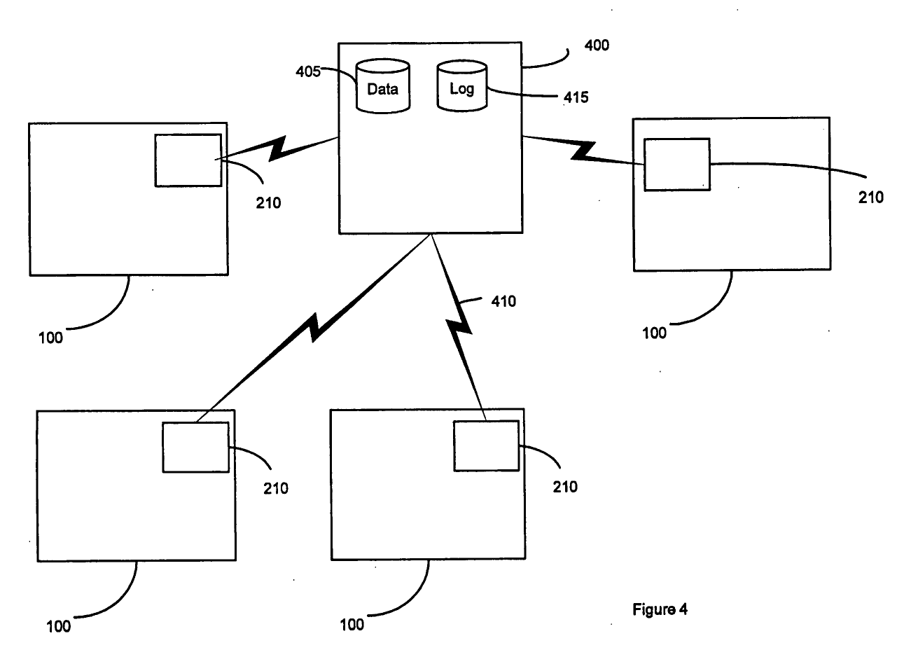

In order to upload new content it is important that the devices of the invention can interface with a central server 400, which is managed by a content provider (CP). The content provider may analyze historical data when compiling new content for a specific use group (UG) which in the case of airline usage could be considered all flights of that airline that implement and provide devices in accordance with the teaching of the invention. FIG. 4 shows in schematic form such an arrangement where four devices from a use group are being interfaced simultaneously with the central server to provide for an update. The schematic is simplified to show only the interface module 210 of each of the devices 100. During an interface over a communications link 410, new data from the central server data store 405 is uploaded to each of the devices. At the same time logs of the actual viewing content can be downloaded to the server from each of the devices and stored at a viewing log 415 for subsequent analysis.

It will be understood that the portable device of the invention provides for storage of a large amount of digital data on the device. Such data has an intrinsic value and it is important that persons of unscrupulous nature cannot extract that data for nefarious purposes. To provide for a protection of the stored data, the device of the present invention may employ encryption techniques such as those used for digital rights management (DRM). Such techniques may attribute different cryptographic keys to both use groups (UG)—which would be represented by all flights of a specific airline on which the devices are used—and other keys for the content manager (CM)—which is the entity that manages the selection and loading of appropriate content onto each device. If employed, such DRM encryption may use a symmetric encryption scheme using for example an AES algorithm for data and asymmetric encryption scheme for content local keys. The Symmetric Keys used will consist of Symmetric Keys of Use Group and Symmetric Keys of the Content stored on the datastore. The Symmetric Keys of Content in turn will be protected using asymmetric encryption logic (which uses the Public key of the Use Group for encryption and Private key of CM for signing) and will be embedded within the content.

The scheme employed tries to achieve good security of the content without overloading the system, so that the user of the device can view contents with minimum possible distraction. This is achieved by controlling the number of keys used and the amount of data that is DRM encrypted without leaking any of the important content information. Also the amount of data encrypted with a given combination of keys is less, thus giving less data to hackers to try and break the keys.

It will be appreciated that each of the audiovisual media items typically include a plurality of frames. One of the M Symmetric Keys of Content may be clubbed together (using for example simple concatenation or mathematical combination functions) with one of the N Symmetric Keys of the Use Group before being used to encrypt the content of a frame. For the next frame the next Symmetric key of content is clubbed with the next Symmetric key of UG for encrypting. And in turn these two sets of keys will be used in a round robin basis individually. Just recovering the Symmetric keys of Content (or only the Symmetric keys of UG) in itself is not sufficient to decode the content AND in turn breaking one of the N symmetric keys' of the Use Group (or Content) is also not sufficient to decode the full content. N, the number of symmetric keys of the use group will typically be odd and M, the number of symmetric keys for the content, will be even.

Only the data part of the content i.e. the visual information related data will need to be encrypted and not the meta data and or header part of each frame. This can be used to stop a hacker from trying to recover the key or its parts using known patterns in the header or meta data. In turn desirably only the first 1 KByte of each frame is encrypted, however additional protection is provided by not using error resilience features.

Some of the Error Resilience features that are not used include:

### No restart markers, No data partitioning, No Forward error correction

### Avoid Reversible VLC if possible

### Don't use rotating Intra Coded blocks across P frames

### Audio DRM scheme

While discussed heretofore with reference to pure audio visual presentations, it will be understood that a device in accordance with the teaching of the invention could also be used to provide storage of audio tracks as well. Such audio storage could be implemented using for example MP3 formats. The MP3 audio, where encrypted, will again encrypt only the Non Header part of the each MP3 frame. Each MP3 audio in turn will use its own content symmetric keys mixed with the UG symmetric keys. Which UG symmetric key, among the N keys, is used as the starting key in the round robin UG symmetric key selection process, will be determined based on additional info in the MP3 file header. A new content symmetric key will be used for roughly every 10 MB of audio data. These content symmetric keys are embedded within the MP3 file after encrypting them with the public key of the UG and signing with the private key of the CM.

In order to decrypt the data that is stored on each device, each device is also provided with one or more decryption keys which are specific to the data that is stored locally. The set of suitable keys may be uploaded in a separate file to the device each time the device is provided with new content. In this way the content of the device, the content package, may be controlled for viewing by that device. In this way, if a content package is created for a specific user group and encrypted, it is also associated with a set of keys that are necessary for decryption. These keys are created for the device that will be used to store the content package and are stored separately on the device.

To control usage of the media items that are stored on the device, and also to restrict tampering of the data, it will be appreciated that the cryptographic techniques described here are exemplary of the type of techniques that could be used to protect data. Other methodologies could include providing decryption keys for the data as part of the activation code, such that presentation of the correct activation code activates the device but also serves to decrypt the data stored thereon.

While a user could simply take the device and walk off the aircraft it will be appreciated that the battery life of such devices is limited. The device may be configured such that if main power is provided that the device will revert to an update mode that will then prevent the user from subsequent viewing of the material on the device.

It will be appreciated that what has been described herein is an exemplary embodiment of a combined in-flight entertainment system that provides a portable device incorporating stored audio visual content and a card activator system. This has a number of advantages including control of viewed content depending on airline, age, class of passenger, etc. By separating billing from viewing such a system can be easily deployed. The device may include a data storage system that optimally separates the audio/visual/subtitle of the stored media items. A further data storage may be provided to separate the font selection for different languages. Such a device also includes a log that monitors the actual content watched and uses this for licensing/advertising purposes.

Also described herein is a content media system for providing in-flight content to users through a plurality of personal in-flight entertainment devices. Each of the devices is provided with a data store which can store media content items for subsequent viewing by a user on board the aircraft. Periodic refreshing of the stored content may be provided by interfacing the individual devices with a content server. Desirably the interface is provided using Ethernet protocols that can enable transfer speeds of up to 100 Mb/sec thereby increasing the turn around speed available. Such Power-Over-Ethernet content loading provision will support much speedier loading and impose less pressure on the carrier's turnaround schedules. With a typical capacity of 2 Gb/sec from the content server to an array of switches, and 100 Mb/sec from the switches to the individual devices, the system will load content as fast as the built-in hard drives of the data stores can receive it. Using such technology it is possible to load over a thousand portable devices simultaneously.

An exemplary portable device in accordance with the teaching of the invention will have a weight of about 1.5 kg, a 80 Gb hard drive, a 8, 10 or 14-hour battery and an 8.4 in/4:3-aspect-ratio screen.

The system provides the facility to enable a user to enter an activation code which is provided on for example a prepaid card which will be sold as part of the normal cabin sales process in the aircraft and then swiped to activate the units. This is advantageous in that this eliminates the need for credit-card handling, with its onboard server and complex logistics. By centrally logging all sales of authentication codes through the cabin staffs handheld sales terminals, there will be a robust log of transactions that is lacking in other arrangements. Such tracking can also be used to ensure that the same activation code is not used on a plurality of devices, or just to track such misuse for future investigation.

While described with reference to the provision of an activation code on a prepaid card, it will be understood that such an embodiment is exemplary of the type of presentation of the code to the user. Alternative examples may include the printing of a code by the seller and the subsequent manual entry of that code by the user. Another typical example could be the use of bar code technology with an integrated bar code reader on the portable device and the use of that reader to effect entry of the activation code. These and other features will be apparent to the person skilled in the art.

An on device intelligence system that logs actual usage patterns of the device offers airlines and their content providers an unprecedented ability to track and record how passengers use the units, yielding intelligence that can be downloaded quickly over the Ethernet link to support new content choices and provide suppliers with verifiable information on how their content is being used. Such information can then be used for billing purposes by the content provider and/or for selectively uploading more relevant content as appropriate to the historical patterns of usage.

While described with reference to an exemplary application in an in-flight entertainment configuration for use on aircraft it will be understood that such an application is only provided for ease of understanding. A device in accordance with the teaching of the invention could be used in any one of a number of transport arrangements where a transport provider wishes to provide entertainment to its passengers. Such arrangements will include bus, train, ship and similar vehicular transport systems and it is intended that the phrase “in-flight” be construed broadly to encompass such arrangements. Further applications include the distribution of such a portable device within a hospital or hotel environment where individual entertainment by the patients/guests may be required.

Therefore while the invention has been described with reference to a preferred embodiment it is not intended to limit the invention in any way except as may be deemed necessary in the light of the appended claims. Modifications can be made and will be apparent to the person skilled in the art without departing from the spirit and/or scope of the invention. Where specific integers are described with reference to one figure it will be understood that such integers or components can be used or interchanged with other components without departing from the teaching of the invention.

The words comprises/comprising when used in this specification are to specify the presence of stated features, integers, steps or components but does not preclude the presence or addition of one or more other features, integers, steps, components or groups thereof.

1. An in-flight portable entertainment device including:
a) a screen,
b) a datastore configured to provide on device storage of a plurality of media items,
c) a user interface through which a user can select one or more of the plurality of media items for display on the screen,
d) an activation code input module through which a user can provide an activation code, and
wherein entry by the user of a correct activation code enables the device and allows the user to select and view stored media items.

2. The device of claim 1 wherein the activation code input module is a card reader, the card reader being configured to read the activation code from a presented card.

3. The device of claim 2 wherein the card reader is a magnetic stripe card reader that is configured to read and process a magnetic stripe on a presented magnetic stripe card.

4. The device of claim 2 wherein the activation code is embedded on the card, a presentation of the card to the card reader effecting an extraction and processing of the code.

5. The device of claim 4 wherein the activation code is digitally encrypted on the card, the device being configured on extraction of the code to decrypt the code.

6. The device of claim 5 wherein the decryption is effected using key encryption technologies, the key being previously stored within the device.

7. The device as claimed in claim 1 wherein the activation code is useable once.

8. The device as claimed in claim 7 wherein the activation code is embedded on a magnetic stripe card which is readable using a magnetic stripe card reader, and the action of striping the card through the reader effects a destruction of the stripe.

9. The device as claimed in claim 8 wherein the destruction is effected by providing a magnet within the device, the magnet being located adjacent to the card reader and wherein the action of swiping the card provides for an interaction between the magnet and the magnetic swipe and a destruction of at least a portion of the data stored on the stripe.

10. The device as claimed in claim 7 wherein the activation code is embedded on a smart card which is readable using a smart card reader, and wherein the smart card reader includes a writing function, such that the presentation of the card to the reader effects a writing to the card and disablement of the activation code for subsequent usage.

11. The device as claimed in claim 1 wherein the activation code is useable to determine which of the plurality of available media items are available for viewing by the user.

12. The device as claimed in claim 11 wherein the plurality of available media items are divisible into individual profile sets, the activation code providing a determination as to which of the profile sets are viewable by the user.

13. The device as claimed in claim 12 wherein the profile sets include at least one profile set determined by a viewer's age such that content on the device may be restricted based on that appropriate to the viewer's age.

14. The device as claimed in claim 13 wherein the format of the presented activation code is identifiable by the device upon the processing of the code as to the appropriate profile set available for viewing.

15. The device as claimed in claim 1 including a first data log, the first data log configured to store details of the authentication code used to select the available media items.

16. The device as claimed in claim 15 wherein each activation code enables a predetermined activation period of the device, the first data log being configured to monitor the usage of the device using a specific authentication code and to provide for a disablement of the device on determination that the usage period exceeds the activation period.

17. The device as claimed in claim 1 further including a second data log, the data log including a record of which of the plurality of media items have been viewed using that device.

18. The device as claimed in claim 17 wherein the second data log is writeable to by the device each time a user selects and views a specific media item.

19. The device as claimed in claim 17 wherein the second data log is encrypted.

20. The device as claimed in claim 17 wherein the second data log does not store details of the activation code used to access specific media items.

21. The device as claimed in claim 1 including a data exchange port, the data exchange port enabling a writing of data to the device and retrieval of data from the device.

22. The device as claimed in claim 18 wherein the data exchange port facilitates a periodic update of the media items stored on the device.

23. The device as claimed in claim 21 wherein the data exchange port facilitates the retrieval of data from the device, the data including information relating to the usage patterns of the device.

24. The device as claimed in claim 19 wherein the data exchange port uses an Ethernet protocol.

25. The device as claimed in claim 24 wherein the data exchange port supports power over Ethernet.

26. The device as claimed in claim 1 further including a battery.

27. The device as claimed in claim 26 wherein the battery is rechargeable.

28. The device as claimed in claim 1 being dimensioned to be locatable in an aircraft passenger seat.

29. The device as claimed in claim 1 wherein the media items include at least one of movies, recorded TV programs, audio only output, and games.

30. The device as claimed in claim 1 wherein the media items include audio visual elements, the audio and visual subcomponents being storable separable to one another, the device including a processing element configured to combine appropriate audio visual subcomponents on selection by a user for viewing.

31. The device as claimed in claim 30 wherein one visual subcomponent is associated with a plurality of different audio subcomponents, each of the different audio subcomponents differing in their language.

32. The device as claimed in claim 31 wherein the processing element is configured to combine an appropriate language with a selected visual subcomponent on identification of an appropriate language for the user.

33. The device as claimed in claim 32 wherein the identification of the appropriate language is determined based on the format of the activation code.

34. The device as claimed in claim 32 wherein the identification of the appropriate language is determined based on a user input parameter.

35. The device as claimed in claim 1 wherein the datastore is encrypted such that data stored on the datastore can only be accessed through the device on which the datastore is located.

36. The device as claimed in claim 1 wherein each of the one or more of the plurality of media items have a secondary associated preview file, the preview file for each of the media items being viewable by the user prior to entry of the activation code.

37. The device as claimed in claim 1 wherein the content of the device is viewable by the user prior to entry of the activation code so as to enable a user to browse through the available media items, the entry of the activation code enabling a complete viewing of selected items subsequent to the browsing.

38. An in-flight content media delivery system, the system including at least one content server having a plurality of packaged media items, the packaged media items being deliverable to one or more individual in-flight portable entertainment devices, the portable entertainment devices storing the delivered items on a local hard drive, the delivery being provided using an Ethernet based content loading module, and wherein the module is configured to provide data from the content server to a plurality of switches at a first transfer rate and from the plurality of switches to hard drives of the individual in-flight portable entertainment devices at a second transfer rate, the second transfer rate being equivalent to the read speed of the hard drives.

39. The system as claimed in claim 1 wherein the first transfer rate is about 2 Gb/sec and the second transfer rate is about 100 Mb/sec.

40. A method of providing an in-flight entertainment system, the method comprising the steps of:
a) Providing a plurality of individual portable in-flight entertainment devices, each of the devices being operable by a user, the devices including
i) a screen,
ii) a datastore configured to provide on device storage of a plurality of media items,
iii) a user interface through which the user can select one or more of the plurality of media items for display on the screen,
iv) an activation code input module through which the user can provide an activation code, entry by the user of a correct activation code enabling the device and allowing the user to select and view stored media items,
b) Providing a centralised sale of a plurality of activation codes, the sale being facilitated and processed through a flight attendant, and
wherein on purchase of an activation code by a user, the user may enter the code into the device, thereby enabling the device and allowing the user to select and view stored media items.

41. The system as claimed in claim 40 wherein the each of plurality of activation codes are stored on individual cards, the cards being sold separately to a user.

42. The system as claimed in claim 40 wherein the cards are differentiable such that definable sub-sets of the stored media items are selectable by a user on presentation of a suitable card.

43. The system as claimed in claim 42 wherein the differentiation of the cards is based on user age profiles.
